(19) United States
(12) Patent Application Publication
(10) Pub. No.: US 2012/0168254 A1
(43) Pub. Date: Jul. 5, 2012

(54) Common Power Lubricated Gearboxes on Combine Harvester

(75) Inventors: Robert A. Matousek, Milan, IL (US); Joshua J. Wolters, Atwood, KS (US)

(73) Assignee: AGCO CORPORATION, Duluth, GA (US)

(21) Appl. No.: 13/323,879

(22) Filed: Dec. 13, 2011

Related U.S. Application Data
(60) Provisional application No. 61/422,335, filed on Dec. 13, 2010.

(51) Int. Cl. F16H 57/04; F01M 5/00; A01D 41/12; F01M 1/02; F16N 7/40

(52) U.S. Cl. 184/6.12

(57) ABSTRACT

In one embodiment, a lubricant distribution system for a combine harvester, the lubricant distribution system comprising: a plurality of gearboxes coupled to different locations on the combine harvester, each of the plurality of gearboxes comprising lubricating fluid; a reservoir configured to receive the lubricating fluid from the plurality of gearboxes; and a pump configured to pump the lubricating fluid received from the reservoir to the plurality of gearboxes.

### RELATED APPLICATION

Under provisions of 35 U.S.C. §119(e), Applicants claim the benefit of U.S. Provisional Application No. 61/422,335 filed Dec. 13, 2010, which is incorporated herein by reference.

### TECHNICAL FIELD

The present disclosure generally relates to combine harvester gearbox lubrication systems.

### BACKGROUND

Combine harvesters (or also referred to simply as combines) today are complex machines used in the harvesting and threshing of a variety of crops. Combine harvesters typically comprise one or more gearboxes that provide speed and/or torque conversions from a power source to another device. A gearbox typically comprises a reservoir of lubricating fluid (e.g., oil), the lubricating fluid circulated within the gearbox through movement of the gears.

### SUMMARY

In one embodiment, a lubricant distribution system for a combine harvester, the lubricant distribution system comprising: a plurality of gearboxes coupled to different locations on the combine harvester, each of the plurality of gearboxes comprising lubricating fluid; a reservoir configured to receive the lubricating fluid from the plurality of gearboxes; and a pump configured to pump the lubricating fluid received from the reservoir to the plurality of gearboxes.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an embodiment of an example lubricant distribution system as part of an example combine harvester.

FIG. 2A is a block diagram of one embodiment of an example lubricant distribution system arranged in a parallel manner of distribution with a pump and reservoir located below a plurality of gearboxes.

FIG. 2B is a block diagram of one embodiment of an example lubricant distribution system arranged in a serial manner of distribution with a pump and reservoir located below a plurality of gearboxes.

FIG. 3 is a block diagram of one embodiment of an example lubricant distribution system arranged in a parallel manner of distribution with a reservoir, having a bottom outlet port, located above a plurality of gearboxes.

FIG. 4 is a block diagram of one embodiment of an example lubricant distribution system arranged in a parallel manner of distribution with a reservoir, having a top outlet port, located above a plurality of gearboxes.

FIG. 5 is a flow diagram of one embodiment of an example lubricant distribution method.

### DETAILED DESCRIPTION

Certain embodiments of a lubricant distribution system and method (herein, collectively referred to as a lubricant distribution system) for a combine harvester are disclosed. Example embodiments include a system having multiple gearboxes that are arranged in a circuit (e.g., parallel, series, or a combination of both) in which cooled lubricating fluid (e.g., oil) flows through a medium (e.g., metal or non-metal tubing) to lubricate gears and bearings in each of the multiple gearboxes. By flowing lubricating fluid through all of the gearboxes at once, heat generation is addressed for each gearbox with limited design expenditure at the design-stage as to which gearbox needs special heat mitigation considerations (e.g., based on load). Another possible benefit of certain embodiments of the lubricant distribution system, among others, is that the lubricating fluid level is lowered, yet to a suitable level, preventing or reducing excessive churning of the lubricating fluid caused by excessive fluid levels and hence further reducing heat creation and increasing power transmission efficiency.

In general, a conventional gearbox comprises a reservoir of lubricating fluid, where movement of the gears causes circulation within the box and hence cooling by conduction through the gearbox wall and convection into the air. However, filling the gearbox with an excessive volume of the lubricating fluid may result in friction (e.g., churning) heating of the lubricating fluid, which may actually overheat the box. Thus, whereas providing for an increased lubricating fluid capacity may enhance cooling, too much of the lubricating fluid level within the gearbox may cause its own, possibly severe, heating. Further complicating the design of a proper gearbox system is that there is a risk of poor lubrication of gears and/or bearings if the lubricating fluid level is too low.

Certain embodiments of lubricant distribution systems disclosed herein address one or more of these issues. In one lubricant distribution system embodiment comprising a plurality of gearboxes, a reservoir is placed at or below a level (e.g., height) of a lowest gearbox, and one or more pumps are used to pump the lubricating fluid from the reservoir to all gearboxes requiring lubrication fluid. A manifold and/or other common hydraulic components are used to distribute the lubricating fluid as needed. A drain line is provided such that the lubricating fluid pumped to a given gearbox drains by gravity back to the reservoir.

The following detailed description refers to the accompanying drawings. Wherever possible, the same reference numbers are used in the drawings and the following description to refer to the same or similar elements. While certain embodiments of the disclosure may be described, modifications, adaptations, and other implementations are possible as should be understood by one having ordinary skill in the art in the context of the disclosure. For example, substitutions (e.g., other lubricating fluid than oil may be used), additions, or modifications may be made to the elements illustrated in the drawings, and the methods described herein may be modified by substituting, reordering, or adding stages to the disclosed methods.

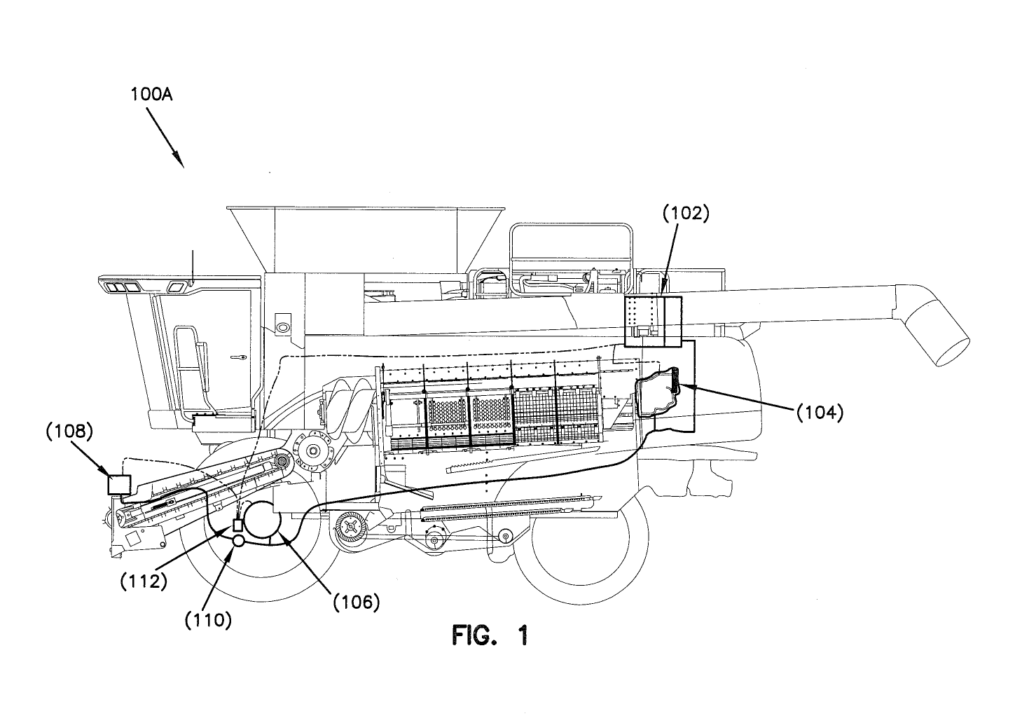

Referring to FIG. 1, shown is a schematic diagram of an embodiment of an example lubricant distribution system 100A, embodied as part of an example combine harvester. It should be understood by one having ordinary skill in the art, in the context of the present disclosure, that the example components illustrated in FIG. 1 are merely illustrative, and should not be construed as implying any limitations upon the scope of the disclosure. In particular, the lubricant distribution system 100A comprises a plurality of gearboxes coupled to the combine harvester in various locations as part of a circuit, including a main engine gearbox 102, a rotor drive gearbox 104, wheel (final) drive gearbox 106, and a header drive gearbox 108. In some embodiments, there may be fewer or more gearboxes, and/or different gearboxes. For instance, another gearbox that may be added in some embodiments (or used in lieu of other gearboxes in some embodiments) is a ground drive transmission. The lubricant distribution system 100A further comprises, as part of the circuit coupled to the combine harvester, a reservoir 110 and a hydraulic pump 112, and optionally a cooling device (not shown in FIG. 1—obscured from view). In some embodiments, more than a single pump 112 may be used.

The reservoir 110 is illustrated as a single purpose oil reservoir, but in some embodiments, may be formed by sealing a portion of the combine frame (e.g., comprising a sealed, welded frame member). The reservoir 110 may be cooled directly by placing it in a location where air flows over it (e.g., exposed to outdoor air, or the airflow may be created by inlet air to the combine cleaning fan, among other sources of cooling air). In some embodiments, a specific lubricating fluid cooler (e.g., heat exchanger) may be added through which the lubricating fluid may flow. Though shown in the present and subsequent figures as a separate entity, in some embodiments, the reservoir 110 may be co-located (e.g., integrated with) with one or more of the gearboxes 102, 104, 106, and/or 108.

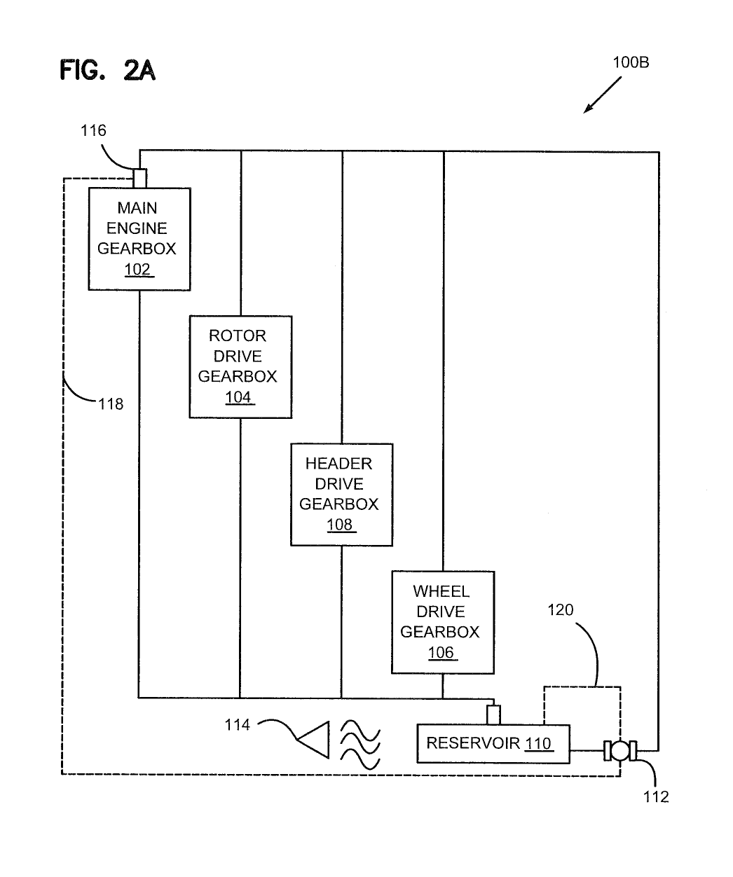

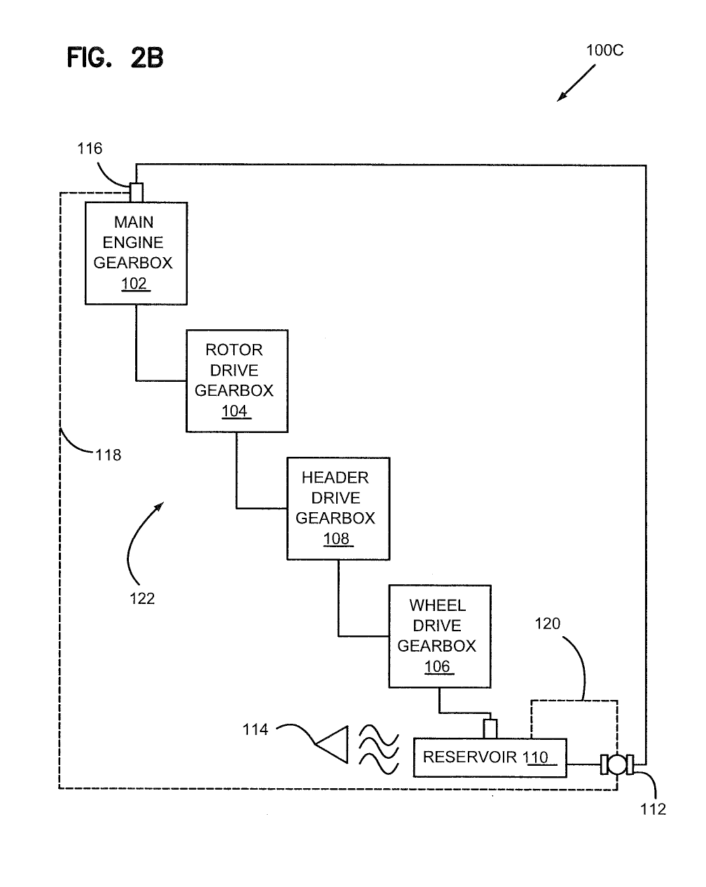

An example lubricant distribution system 1008 and manner of operation are further described in FIG. 2A. The lubricant distribution system 1008 is similar to that described and illustrated in FIG. 1, without an illustration of the entire combine harvester in order to facilitate the understanding of the disclosure. The lubricant distribution system 100B comprises similar components (e.g., 102, 104, 106, 108, 110, and 112) to those illustrated in FIG. 1, and hence discussion of the same is omitted here for brevity except as noted below. Note that the differences in height of each of the components is illustrative and used as one example among many other possible examples. Further illustrated in FIG. 2A is a cooling device 114 (e.g., a fan or air inlet or radiator) that acts as a source of cooling air to the reservoir 110, and optionally one or more sensors 116 (one shown in FIG. 2A). In some embodiments, the sensor 116 may be omitted, or in some embodiments, the sensor 116 may be located elsewhere. In some embodiments, the cooling device 114 may be located elsewhere within the circuit (e.g., an exchanger located between the pump 112 and the gearboxes 102-108, etc.).

The sensor 116 may be configured to detect level, temperature, pressure, fluid flow, and/or other lubricating fluid variables within the main engine gearbox 102 and/or reservoir 110, particularly for preventing or mitigating the possibility of catastrophic failures. The sensor 116 may communicate an actuation signal (e.g., to cause on/off control of an actuated device) or a status signal (e.g., where intelligence resides in the actuated device to make a determination whether commencement of operation of the receiving device should begin or current operations should cease based on the received status information). The actuation or status signal may be communicated as a digital signal or analog signal, and in some embodiments, according to one or more industry-recognized protocols (e.g., FieldBus, CAN, etc.) or proprietary protocols. Communication of the actuation or status may occur wirelessly in some embodiments, or in the illustrated embodiment, occur via a control line 118. Note that control lines described herein and represented with dashed lines may be embodied as a tangible, conductive medium in some embodiments, as a wireless medium in some embodiments, or as a combination of both in some embodiments.

In one embodiment, the sensor 116 communicates an actuation signal (e.g., on/off) over the control line 118 to a switch on the pump 112 based on the temperature of the lubricating fluid in the gearbox 102 exceeding a defined threshold level. In response to the signal, the pump 112 actuates, causing circulation of the lubricating fluid from the reservoir 110 to the plurality of gearboxes 102-108. In some embodiments, the pump 112 may be actuated in conjunction with a communication signal communicated contemporaneously between the pump 112 and the reservoir 110 over a control line 120 (or wirelessly in some embodiments), causing the lubricating fluid to be released (e.g., via opening of an actuable port or orifice or valve internal to, or coupled to, the reservoir 110) from the reservoir 110 and circulated by the pump 112 to all of the gearboxes 102-108. In some embodiments, the actuation signal may be provided only to the reservoir 110, which in turn actuates the pump 112 via the control line 120. In some embodiments, actuation of the pump 112 may occur merely upon engagement of power to one or more gearboxes 102, 104, 106, and/or 108, or in some embodiments, based on the powering of the lowest gearbox (e.g., gearbox 106) that drives the pump 112.

Note that some components may be omitted from the drawings to facilitate an understanding of the various embodiments without undue complication. For instance, the system 100A, 100B (and other system embodiments described hereinafter) described herein may further comprise filtering component(s) to mitigate or prevent the risk of a given gearbox precipitating failure of another gearbox or other system component by migration of metal through the system.

Referring to FIG. 2B, shown is an example lubricant distribution system 100C with similar components (e.g., 102, 104, 106, 108, 110, 112, 114, 116, 118, 120) to those illustrated in FIG. 2A, yet where the circuit of gearbox components is arranged in a serial configuration 122. The choice of serial versus parallel, a choice which similarly applies to each embodiment described herein, is based on many design considerations, such as the risk of contaminants from each gearbox traveling to the next, cost of fluid lines, overall flow rate, among others.

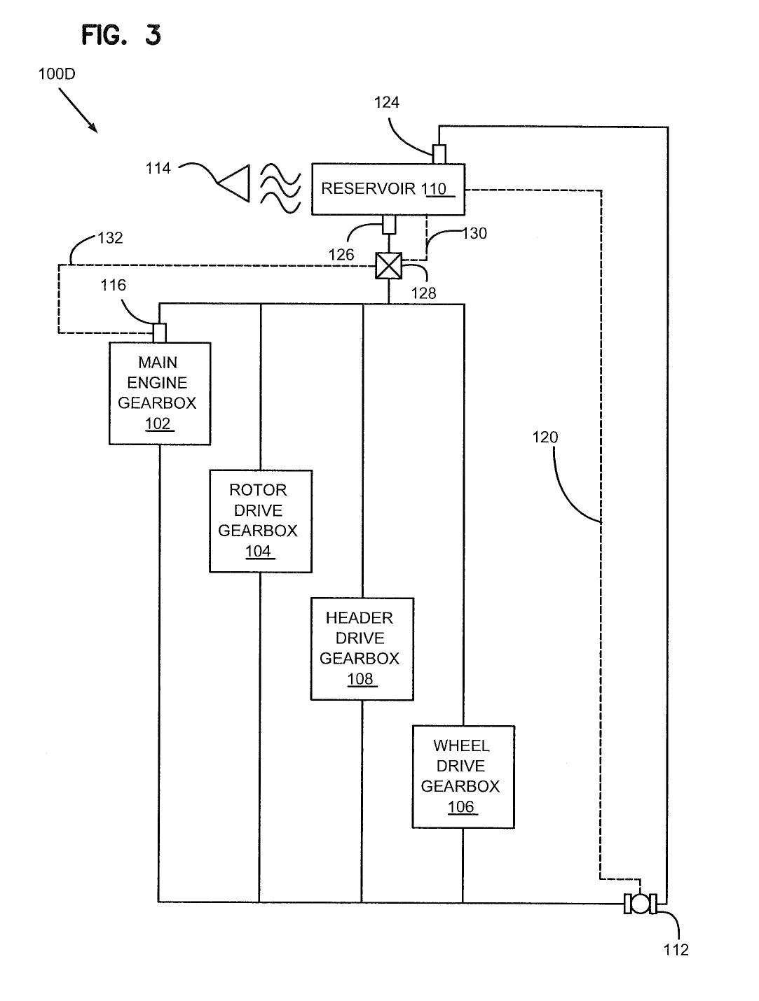

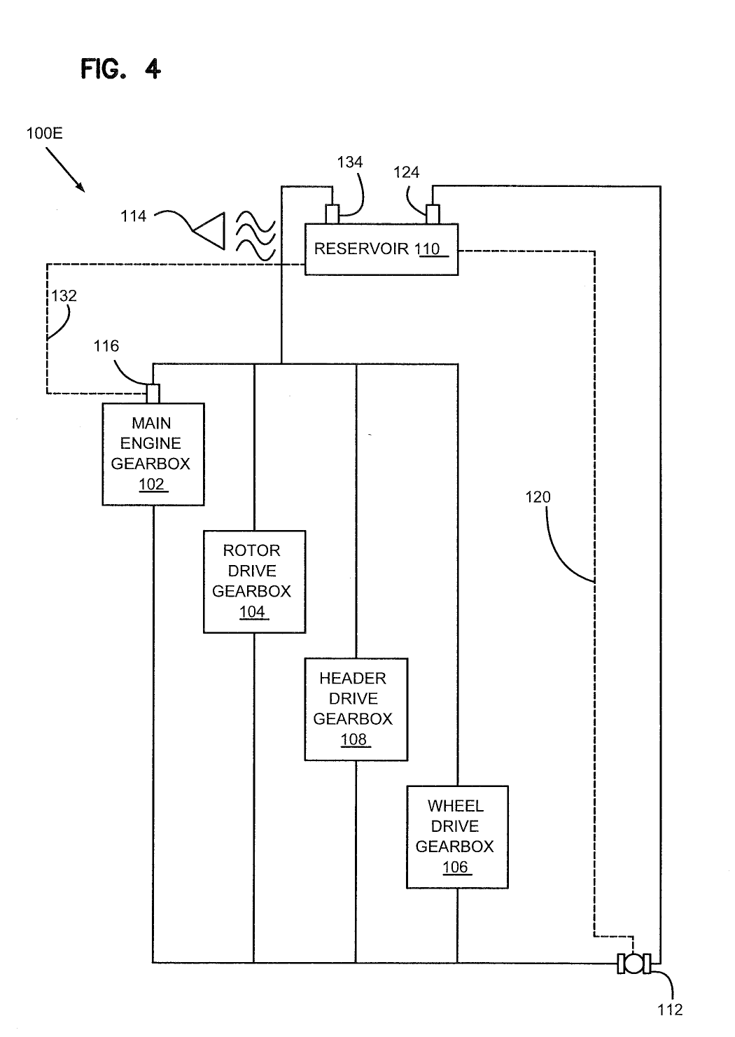

Having described certain embodiments where the pump and reservoir are located at or below the lowest residing gearbox (e.g., wheel drive gearbox 106 in these examples, though not limited to the wheel drive gearbox 106), enabling gravity feed of the lubricating fluid once pumped to the top of the circuit, attention is now directed to lubricant distribution systems 100D (FIG. 3) and 100E (FIG. 4) where the reservoir 110 is located above the highest residing gearbox (e.g., main engine gearbox 102 in these examples, though not limited to the main engine gearbox 102) and the pump 112. Referring to FIG. 3, the description of like components (e.g., components 102-120) are omitted for brevity, except as noted below. It is noted that, though a parallel configuration is shown in FIGS. 3-4, a serial configuration may be employed in some embodiments. In the example lubricant distribution systems 100D shown in FIG. 3, the reservoir 110 comprises multiple ports, including a top inlet port 124 and a bottom outlet port 126.

Also shown is a controlling device (e.g., on/off valve) 128 that is actuated by the reservoir 110 over a control line 130 (though similar to the embodiments described above, may be actuated wirelessly). In some embodiments, the controlling device functionality may be incorporated in the reservoir 110 (e.g., in the port) in lieu of the controlling device 128. The optional sensor 116 (and/or other sensors not shown) may communicate with the controlling device 128 when one or more sensed variables surpass a defined threshold. The reservoir 110, as in the example embodiments described above, may cause the controlling device 128 to open based on the lubricating fluid level in the reservoir 110 exceeding a defined threshold level, causing the lubricating fluid to be provided to the plurality of gearboxes 102-108 based on gravity feed, and subsequently pumped back to the reservoir 110 via pump 112 (e.g., actuated via an actuation signal on control line 120 either contemporaneously with the controlling device 128 or with a built-in, timed delay). In some embodiments, the control line 120 may be coupled between the controlling device 128 and the pump 112.

FIG. 4 illustrates another example embodiment of a lubricant distribution system 100E with a top-most residing reservoir 110. The components 102-120 and 124 are similarly configured as described in association with FIG. 3, and hence discussion of the same is omitted for brevity. Further, the reservoir 110 comprises a top outlet port 134, where responsive to the level of the lubricating fluid exceeding a defined threshold level in the reservoir 110, spills out of the top port 134 and is provided to the plurality of gearboxes 102-108 via gravity feed. Contemporaneously (or delayed in some embodiments) with respect to the exceeding (or meeting in some embodiments) of the defined threshold level, the reservoir 110 triggers via control line 120 the actuation of the pump 112, causing the pump to circulate the lubricating fluid that accumulates from the gearboxes 102-108 back to the reservoir 110.

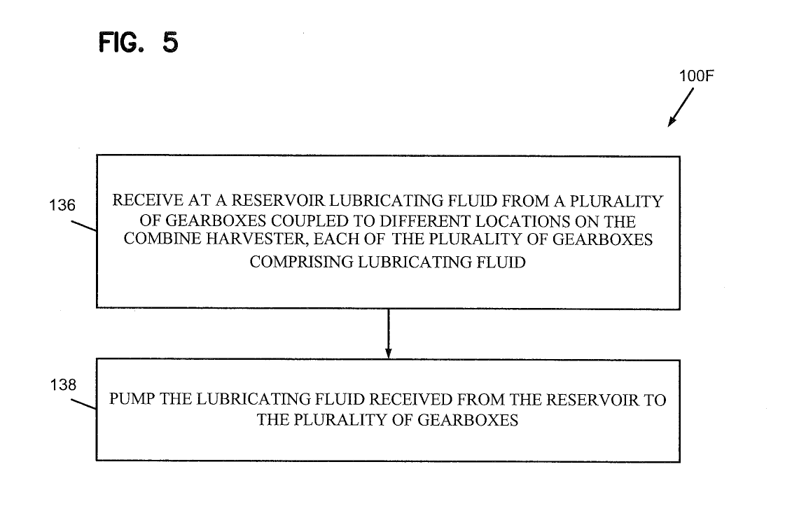

Having described certain embodiments of lubricant distribution systems 100, it should be appreciated that one method embodiment 100F, illustrated in FIG. 5, comprises receiving at a reservoir lubricating fluid from a plurality of gearboxes coupled to different locations on the combine harvester, each of the plurality of gearboxes comprising lubricating fluid (136), and pumping (e.g., via pump 112) the lubricating fluid received from the reservoir to the plurality of gearboxes (138).

It should be emphasized that the above-described embodiments of the present disclosure are merely possible examples of implementations, merely set forth for a clear understanding of the principles of lubricant distribution system embodiments. Many variations and modifications may be made to the above-described embodiment(s) without departing substantially from the spirit and principles of the disclosure. Although all such modifications and variations are intended to be included herein within the scope of this disclosure and protected by the following claims, the following claims are not necessarily limited to the particular embodiments set out in the description.

What is claimed is:

1. A lubricant distribution system for a combine harvester, the lubricant distribution system comprising:
a plurality of gearboxes coupled to different locations on the combine harvester, each of the plurality of gearboxes comprising lubricating fluid;
a reservoir configured to receive the lubricating fluid from the plurality of gearboxes; and
a pump configured to pump the lubricating fluid received from the reservoir to the plurality of gearboxes.

2. The lubricant distribution system of claim 1, wherein the plurality of gearboxes comprises two or more of a header drive gearbox, a wheel drive gearbox, a rotor drive gearbox, a ground drive transmission gearbox, or a main engine gearbox.

3. The lubricant distribution system of claim 1, wherein at least a portion of the plurality of gearboxes is located above the pump and the reservoir.

4. The lubricant distribution system of claim 1, wherein the pump is configured to initiate the pumping of the lubricating fluid responsive to a threshold level of lubricating fluid being met or exceeded at the reservoir.

5. The lubricant distribution system of claim 1, further comprising a sensor disposed proximal to at least one of the plurality of gearboxes, wherein the pump is configured to initiate the pumping of the lubricating fluid responsive to the lubricating fluid reaching a level, sensed by the sensor, that is lower than a threshold level at the at least one of the plurality of gearboxes.

6. The lubricant distribution system of claim 1, further comprising a sensor disposed proximal to at least one of the plurality of gearboxes, wherein the pump is configured to initiate the pumping of the lubricating fluid responsive to the lubricating fluid reaching a level, sensed by the sensor, that is higher than a threshold level at the at least one of the plurality of gearboxes.

7. The lubricant distribution system of claim 1, further comprising a cooling device positioned on the combine harvester and through which the lubricating fluid flows.

8. A lubricant distribution system for a combine harvester, the lubricant distribution system comprising:
a plurality of gearboxes coupled to different locations on the combine harvester, each of the plurality of gearboxes comprising lubricating fluid;
a reservoir configured to provide the lubricating fluid to the plurality of gearboxes; and
a pump configured to pump the lubricating fluid received from the plurality of gearboxes to the reservoir.

9. The lubricant distribution system of claim 8, wherein the plurality of gearboxes comprises two or more of a header drive gearbox, a wheel drive gearbox, a rotor drive gearbox, a ground drive transmission gearbox, or a main engine gearbox.

10. The lubricant distribution system of claim 8, wherein at least a portion of the plurality of gearboxes and the pump is located below the reservoir.

11. The lubricant distribution system of claim 8, wherein the reservoir comprises a port disposed at the top of the reservoir, wherein the lubricating fluid flows to the plurality of gearboxes and to the pump through the port.

12. The lubricant distribution system of claim 8, further comprising a port disposed at the bottom of the reservoir and a controlling device coupled to the port, wherein the lubricating fluid flows to the plurality of pumps through the port responsive to actuation of the controlling device.

13. The lubricant distribution system of claim 8, wherein the lubricating fluid is discharged from the reservoir responsive to a threshold level of lubricating fluid being met or exceeded at the reservoir.

14. The lubricant distribution system of claim 8, further comprising a sensor disposed proximal to at least one of the plurality of gearboxes, wherein the reservoir provides the lubricating fluid responsive to the lubricating fluid reaching a level, sensed by the sensor, that is lower than a threshold level at the at least one of the plurality of gearboxes.

15. The lubricant distribution system of claim 8, further comprising a sensor disposed proximal to at least one of the plurality of gearboxes, wherein the reservoir provides the lubricating fluid responsive to the lubricating fluid reaching a level, sensed by the sensor, that is higher than a threshold level at the at least one of the plurality of gearboxes.

16. The lubricant distribution system of claim 8, further comprising a cooling device positioned on the combine harvester and through which the lubricating fluid flows.

17. A lubricant distribution method for a combine harvester, the method comprising:
receiving at a reservoir lubricating fluid from a plurality of gearboxes coupled to different locations on the combine harvester, each of the plurality of gearboxes comprising lubricating fluid; and
pumping the lubricating fluid received from the reservoir to the plurality of gearboxes.

18. The lubricant distribution method of claim 17, wherein the pumping comprises pumping the lubricating fluid to the plurality of gearboxes responsive to a threshold level of lubricating fluid being met or exceeded at one or more of the reservoir or one of the plurality of gearboxes.

19. The lubricant distribution method of claim 17, wherein the reservoir is integrated within a gearbox.

20. The lubricant distribution method of claim 17, further comprising cooling the lubricating fluid.
